(19) United States
(12) Patent Application Publication
(10) Pub. No.: US 2026/0291991 A1
(43) Pub. Date: Sep. 24, 2026

(54) ARITIFICIAL INTELLIGENCE ('AI') EVENT CORRELATION SYSTEM

(71) Applicant: Bank of America Corporation, Charlotte, NC (US)

(72) Inventors: Steven Sinks, Scottsdale, AZ (US); Joshua Abraham, Sharon, MA (US); Jonathan Sheedy, Poynton (GB)

(21) Appl. No.: 19/088,277

(22) Filed: Mar. 24, 2025

(51) Int. Cl. H04L 9/40

(52) U.S. Cl. CPC H04L 63/20; H04L 63/102; H04L 63/1416

(57) ABSTRACT

A system for isolating intruders within a data network is provided. The system may include a processor operating with an AI engine. The processor may continually crawl the network and retrieve data relating to telemetry of a user. The processor may structure the data into data structures ingestible by an empty matrix. The processor may input the data structures into the empty matrix to generate a baseline matrix for the user. The processor may crawl the data network and retrieve current user data. The processor may structure the current user data into current data structures ingestible by a second matrix. The processor may input the current data structures into the second matrix to generate a current matrix for the user. The processor may electronically generate a delta between the baseline matrix and the current matrix. When the delta exceeds a delta threshold, the processor may terminate activities of the user.

### FIELD OF TECHNOLOGY

Aspects of the disclosure relate to fraud and threat detection.

### BACKGROUND OF THE DISCLOSURE

The cybersecurity industry has grown significantly in recent years. Cybersecurity systems utilize both hardware and software to protect data and information stored on computer networks. Conventional cybersecurity systems focus on gatekeeping entry points to both software applications and hardware locations.

However, once a user of malicious intent has penetrated the safeguards protecting an application, current cybersecurity solutions are incapable of detecting nefarious activity. Because current cybersecurity solutions are incapable of detecting nefarious activity, when a user of malicious intent utilizes known applications or network-approved solutions, current cybersecurity solutions do not provide a mechanism for identifying, within the known applications, the user of malicious intent. Furthermore, current cybersecurity solutions do not provide a mechanism for halting, within the known applications, activities of such a user.

As such, it would be desirable to provide a system that detects nefarious activities and identifies perpetrators operating within a computer network firewall.

It would be further desirable for such a system to prevent execution of the nefarious activities.

### SUMMARY OF THE DISCLOSURE

Systems, apparatus and methods for detecting, terminating and preventing nefarious actions within a computing network is provided. Systems may isolate intruders within a data network.

Systems may include a processor. The processor may operate within the data network. The processor may operate in a pre-processing stage. The processor may operate in a processing stage.

During the pre-processing stage, the processor may continually crawl the data network and retrieve data relating to telemetry of a user within the data network. The network may be crawled during a time period initiated upon the instantiation of one or more predetermined triggers and concluded at a current timestamp or a predetermined timestamp. The one or more predetermined triggers may relate to user activity. Examples of the one or more predetermined triggers may include change in role of the user, change in manager of the user, change in position of the user and change in geolocation of the user.

During the data retrieval process and upon completion of the data retrieval process, the processor may continually structure the collected data into one or more data structures ingestible by a matrix.

Use of a matrix may enable the processor to generate a multifaceted behavior baseline for the user. The multifaceted baseline may describe user activity and behavior from multiple viewpoints. The multifaceted baseline may illustrate normal user activity within a predetermined time. As such, the matrix may characterize normal behavior and normal activity for the user.

Examples of normal behavior and activity may include one or more accessed applications and one or more accessed files. Examples of normal behavior may include what application is used to access a file, such as a text file. Examples of applications used may include a text editor, such as, for example, notepad, a web browser or a command line. The accessed applications and/or accessed files may be dependent on the user and the user's interactions with computing technology and computing devices.

Examples of normal behavior and activity may include one or more words a user typically uses when creating an email or document. The words may be referred to as the prose that identifies the user.

Examples of normal behavior and activity may include computing resources used, such as, for example, network connections, system memory and central processing unit (“CPU”) utilization.

The processor may input the data structures into an empty matrix to generate a baseline matrix for the user. The matrix may correspond to a multifaceted behavior baseline for the user.

During the processing stage, the processor may crawl the data network and retrieve current user data. The current user data may include current user behavior and activity.

The processor may structure the current user data into one or more current user data structures ingestible by a second matrix. The processor may input the one or more current user data structures into a second empty matrix to generate a current matrix for the user. The current matrix may correspond to current multifaceted behavior for the user. The current matrix may characterize current behavior and activity for the user.

During the processing stage, the processor may generate, at an artificial intelligence engine, a delta between the baseline matrix and the current matrix. When the generated delta exceeds a delta threshold, the user may be isolated within the data network and/or user activities within the data network may be terminated.

The delta threshold may involve artificial intelligence. As such, based on the possibilities associated with the user and the area of deviation from the baseline. Examples of higher level possibilities may include access to critical virtual data sources, access to critical physical data sources and origin classification. The artificial intelligence may reduce false positives by creating and/or modifying thresholds appropriate for a line of business associated with the user.

Such a system may define behaviors that are consistent with productivities for different groups of users within an entity. Certain behaviors and activities may be appropriate for a first group of users that access an application on a normal basis. However, those same behaviors and activities may be inappropriate for a second group of users that do not interact with the application on a normal basis.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout and in which:

FIG. 1 shows an illustrative diagram in accordance with principles of the disclosure;

FIG. 2 shows another illustrative diagram in accordance with principles of the disclosure;

FIG. 3 shows still another illustrative diagram in accordance with principles of the disclosure;

FIG. 4 shows yet another illustrative diagram in accordance with principles of the disclosure;

FIG. 5 shows still another illustrative diagram in accordance with principles of the disclosure;

FIG. 6 shows yet another illustrative diagram in accordance with principles of the disclosure;

FIG. 7 shows an illustrative hybrid diagram/flow chart in accordance with principles of the disclosure;

FIG. 8 shows another illustrative hybrid diagram/flow chart in accordance with principles of the disclosure; and

FIG. 9 shows an illustrative flow chart in accordance with principles of the disclosure.

### DETAILED DESCRIPTION OF THE DISCLOSURE

Systems, apparatus and methods for isolating intruders within a data network are provided. A data network may be a network of computing nodes. Each of the computing nodes may include computing components, such as, for example, a hardware processor and a hardware memory. At least one of the nodes may be operable to store data.

The system may include a processor. The processor may operate within the data network.

The processor may continually crawl the data network to retrieve data for a predetermined time period. The retrieved data may relate to telemetry of a user, a computing node within the data network. The user may primary operate the computing node.

The user may operate with a plurality of users, or computing nodes, on the data network. It should be noted that the predetermined time period may be specific to the user/computing node, and/or correspond to user/computing node information, such as, for example, date of hire, manager data of hire, change of manager, geographic location and change of geographic location. As such, each user/computing node within a plurality of users may be assigned a unique predetermined time period. A standard predetermined time period may be sixty days. At times, the predetermined time period may be a continually updating window of time. As such, the predetermined time period may include information for the most recent sixty days (or any other suitable time period).

The retrieved data may also include data relating to the network of users. For example, if a user operates in line of business A, the data may include data relating to all users of line of business A. The retrieved data may include data relating to roles of the user.

The processor may structure the retrieved data into one or more data structures. The one or more data structures may be ingestible by an empty matrix.

The processor may input the data structures into the empty matrix to generate a baseline matrix for the user. The baseline matrix may correspond to a multifaceted behavior baseline for the user. The baseline matrix may characterize normal behavior and normal activity for the user.

Upon generation of the baseline matrix, the processor may crawl the data network to retrieve current user data. The current user data may include current user behavior and activity.

The processor may structure the current user data into one or more current user data structures. The current user data structures may be ingestible by a second empty matrix.

The processor may input the one or more current user data structures into the second empty matrix to generate a current matrix for the user. The current matrix may correspond to current multifaceted behavior for the user. The current matrix may characterize current behavior and activity for the user.

The processor may generate a delta between the baseline matrix and the current matrix at an artificial intelligence engine. When the delta exceeds a delta threshold, the processor may isolate the user within the data network and/or terminate user activities within the data network.

Illustrative method steps may be combined. For example, an illustrative method may include steps shown in connection with another illustrative method.

The steps of methods may be performed in an order other than the order shown or described herein. Embodiments may omit steps shown or described in connection with illustrative methods. Embodiments may include steps that are neither shown nor described in connection with illustrative methods.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

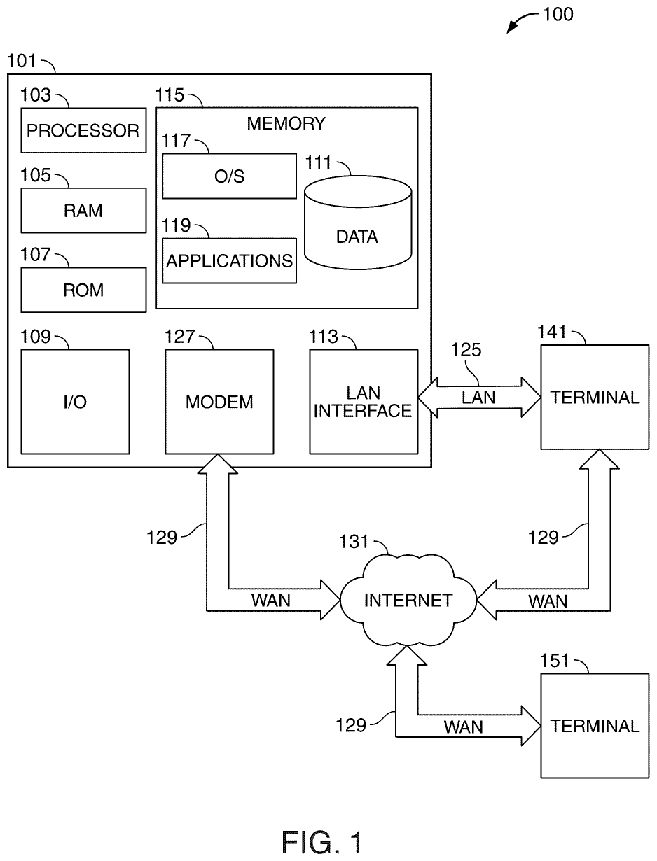

FIG. 1 shows an illustrative block diagram of system 100 that includes computer 101. Computer 101 may alternatively be referred to herein as an “engine,” “server,” or a “computing device.” Computer 101 may be a workstation, desktop, laptop, tablet, smartphone and/or any other suitable computing device. Elements of system 100, including computer 101, may be used to implement various aspects of the systems and methods disclosed herein. Each of the systems, methods and algorithms illustrated below may include some or all of the elements and apparatus of system 100.

Computer 101 may include processor 103 for controlling the operation of the device and its associated components, and may include RAM 105, ROM 107, input/output (“I/O”) 109, and a non-transitory or non-volatile memory 115. Machine-readable memory may be configured to store information in machine-readable data structures.

Processor 103 may also execute software running on the computer. Other components commonly used for computers, such as EEPROM or flash memory or any other suitable components, may also be part of computer 101.

Memory 115 may include any suitable permanent storage technology, such as a hard drive. Memory 115 may store software including the operating system 117 and application program(s) 119 along with any data 111 needed for the operation of the system 100. Memory 115 may also store videos, text and/or audio assistance files. The data stored in memory 115 may also be stored in cache memory and/or any other suitable memory.

I/O module 109 may include connectivity to a microphone, keyboard, touch screen, mouse and/or stylus through which input may be provided into computer 101. The input may include input relating to cursor movement. The input/output module may also include one or more speakers for providing audio output and a video display device for providing textual, audio, audiovisual and/or graphical output. The input and output may be related to computer application functionality.

System 100 may be connected to other systems via a local area network (“LAN”) interface 113. System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include LAN 125 and a wide area network (“WAN”) 129 but may also include other networks. When used in a LAN networking environment, computer 101 may connect to LAN 125 through LAN interface 113 or an adapter. When used in a WAN networking environment, computer 101 may include modem 127 or other means for establishing communications over WAN 129, such as Internet 131.

It will be appreciated if the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or application programming interface (“API”). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may include instructions to store the data in cache memory, the hard drive, secondary memory and/or any other suitable memory.

Additionally, application program(s) 119, which may be used by computer 101, may include computer executable instructions for invoking functionality related to communication, such as e-mail, Short Message Service (“SMS”), and voice input and speech recognition applications. Application program(s) 119 (which may be alternatively referred to herein as “plugins,” “applications,” or “apps”) may include computer executable instructions for invoking functionality related to performing various tasks. Application program(s) 119 may utilize one or more algorithms that process received executable instructions, perform power management routines or other suitable tasks.

The invention may be described in the context of computer-executable instructions, such as application(s) 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered for the purposes of this application, as engines with respect to the performance of the particular tasks to which the programs are assigned.

Computer 101 and/or terminals 141 and 151 may also include various other components, such as a battery, speaker and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 141 and/or terminal 151 may be portable devices such as a laptop, cell phone, tablet, smartphone or any other computing system for receiving, storing, transmitting and/or displaying relevant information. Terminal 141 and/or terminal 151 may be one or more user devices. Terminals 141 and 151 may be identical to system 100 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices, and the like.

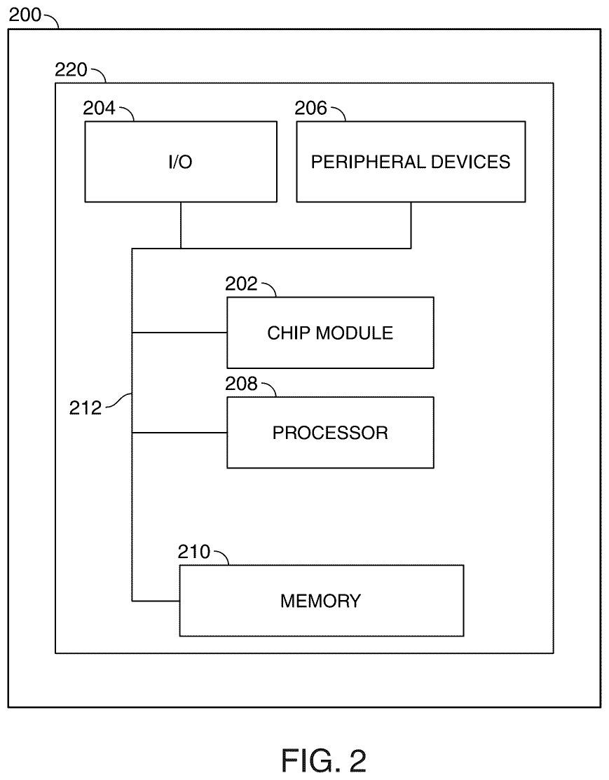

FIG. 2 shows illustrative apparatus 200 that may be configured in accordance with the principles of the disclosure. Apparatus 200 may be a computing device. Apparatus 200 may include one or more features of the apparatus shown in FIG. 1. Apparatus 200 may include chip module 202, which may include one or more integrated circuits, and which may include logic configured to perform any suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 219, signals, and/or any other suitable information or data structures.

Components 202, 204, 206, 208, and 210 may be coupled together by a system bus or other interconnections 212 and may be present on one or more circuit boards such as circuit board 220. In some embodiments, the components may be integrated into a single chip. The chip may be silicon-based.

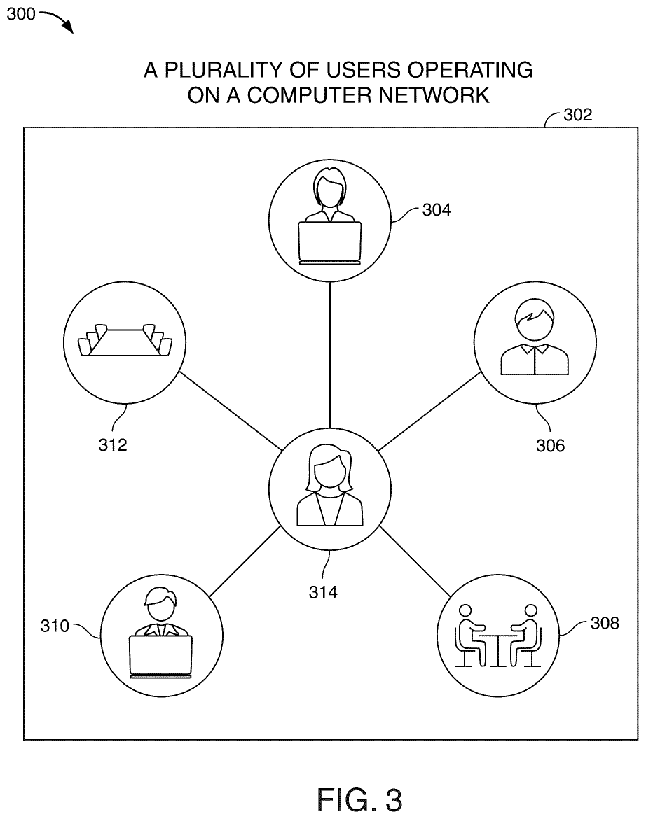

FIG. 3 shows an illustrative diagram. Illustrative diagram 300 shows a data network. A plurality of users may operate on the, or within the data network. Network 302 includes user 304, user 306, group of users 308, user 310, user 314 and group of users 312. Each user, or group of users, within the computer network may have a different role within an entity. Each user, or group of users, within the data network may have different permissions within the data network. As such, each user, or each group of users, may be able to access a different set of resources.

Normal activity and/or behavior for a user may be defined by various parameters. Various parameters may include role, resource allocation and permission set, of the user or group of users within the entity. Additionally, upon the change in a user role, user resource allocation and/or user permission set, normal activity and/or behavior may change.

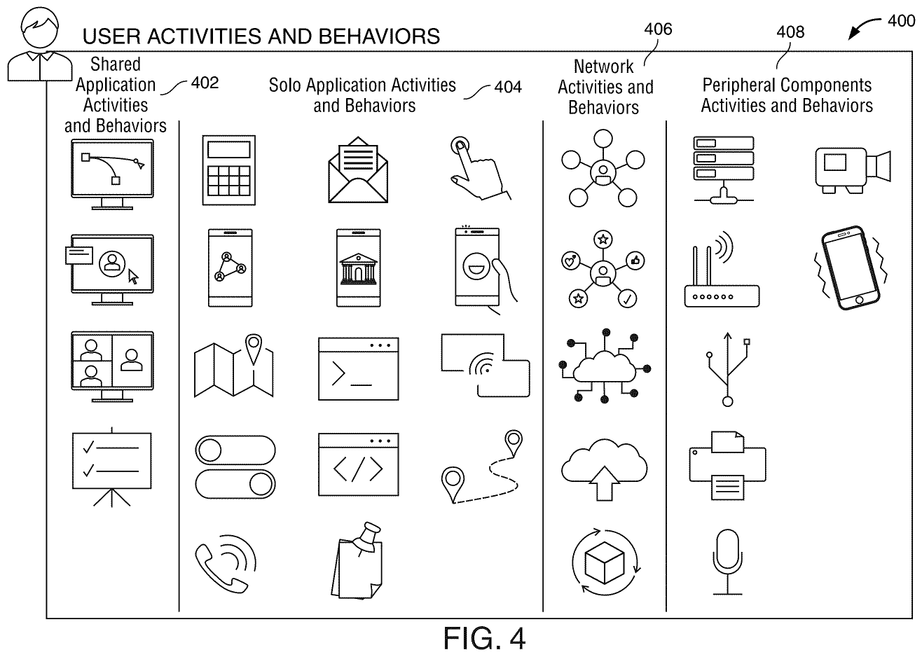

FIG. 4 shows an illustrative diagram. The illustrative diagram shows various user activities and behaviors. The user activities and behaviors may include shared application activities and behaviors 402. Examples of shared user activities and behaviors may include collaborative applications and shared file storage locations.

The user activities and behaviors may include solo application activities and behaviors 404. Examples of solo application activities and behaviors may include applications operated by a single operator, selection of an option by a single operator and geographical location requests.

The user activities and behaviors may include network activities and behaviors 406. Examples of network activities and behaviors may include cloud storage upload and download actions, transfer of information between locations on a network and permission setting of network resources.

The user activities and behaviors may include peripheral components activities and behaviors 408. Examples of peripheral components activities and behaviors may include communication attempts via one or more resources, push notification attempts (e.g., vibration attempts), audio and/or video captures, universal serial port (“USB”) communications, print communications, microphone communications and Bluetooth® communications.

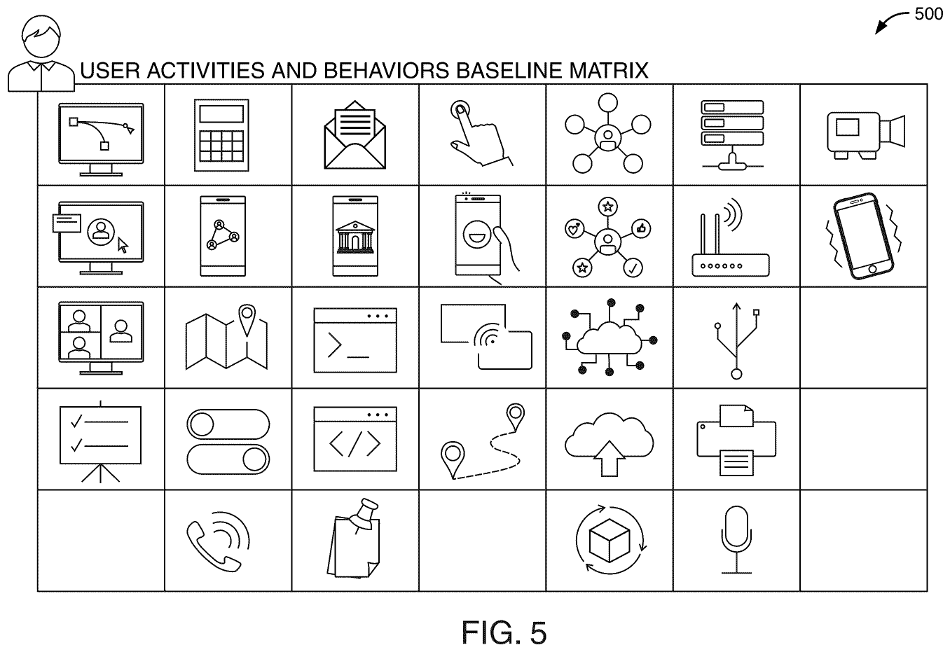

FIG. 5 shows an illustrative diagram. Diagram 500 shows a user activities and behaviors baseline matrix. The user activities and behaviors baseline matrix may include various captured activities and behaviors, as shown in FIG. 4.

It should be noted that a baseline matrix may be generated for a user. The baseline matrix may include various historical activities and behaviors for a user or group of users. The baseline matrix may provide a reference model with which to compare current activities and behaviors.

A current matrix may be generated for the user. The current matrix may include one or more activities and behaviors currently being executed by the user. It should be noted that the current matrix may be a sparse matrix. As such, the current matrix may include relatively small amounts of information. The current matrix may not include a value or vector for each of the activities within the baseline matrix. However, the current matrix may be comparable to the baseline matrix.

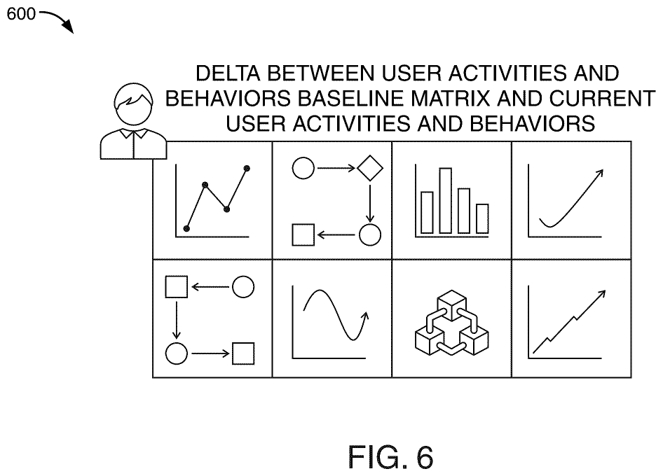

FIG. 6 shows an illustrative diagram. Illustrative diagram 600 may show a delta between the baseline matrix and the current user activities and behaviors. The delta may provide information to the system. Such information may include whether the user is currently operating within a range of normal activity and behavior or whether the user is currently operating outside the range of normal activity and behavior. The information may be used by the system to trigger certain executables, such as, for example, isolating the user within the data network, terminating or preventing user activity and monitoring user application usage.

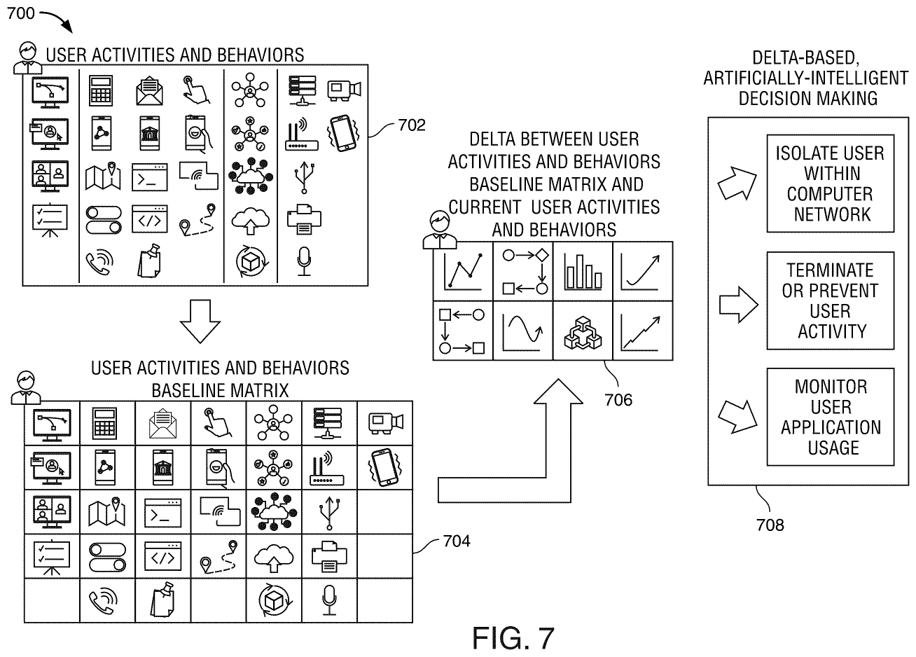

FIG. 7 shows an illustrative hybrid diagram/flow chart 700. Hybrid diagram/flow chart 700 may show an illustrative process flow between user activities and behaviors and executables executed by the system. User activities and behaviors 702 may be processed into matrix 704. A delta between the current user activities and behaviors baseline matrix and the current user activities may be generated, as shown at 706. A delta-based, artificially-intelligent decision making process may be executed by the system, as shown at 708. The delta-based, artificially-intelligent decision making process 708 may include isolating the user within the data network, terminating or preventing user activity and/or monitoring user application usage.

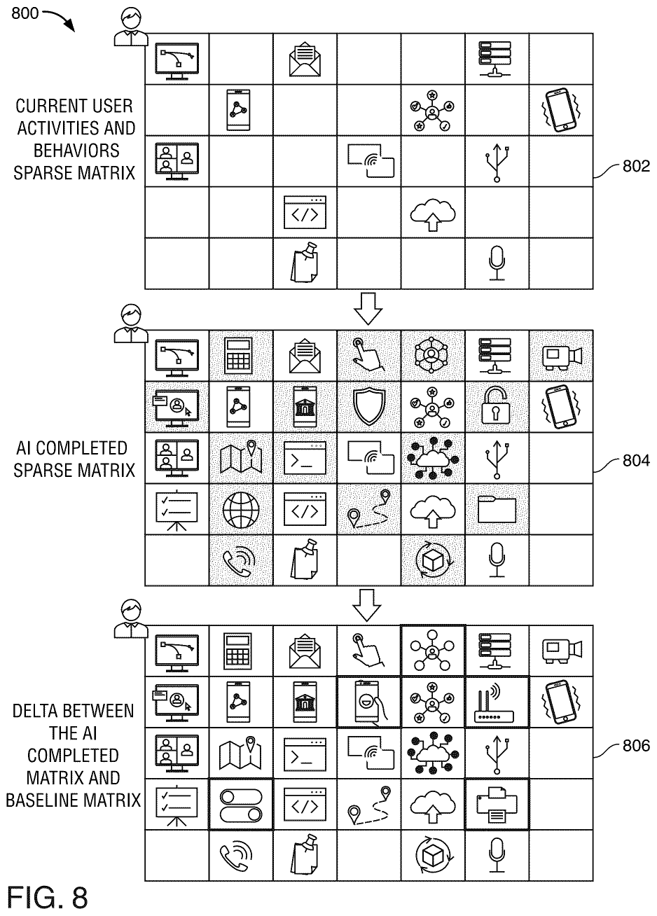

FIG. 8 shows an illustrative hybrid diagram/flow chart 800. At times, a processor may retrieve current user activities and behaviors and use those current activities and behaviors to generate a matrix. However, many times, because the current user activities and behaviors may capture a smaller window of time than the baseline matrix, certain elements or sections of the matrix may remain empty. For example, if a baseline matrix considers sixty days and a current matrix considers 24 hours, the current matrix may not include certain weekly behaviors. The current matrix lacking certain elements or sections may be referred to as a sparse matrix, as shown at 802.

The sparse matrix may be compared to the baseline matrix. The delta between the sparse matrix and the baseline matrix may be a significant delta (over a threshold) because the sparse matrix may lack certain elements or sections. The significant delta may cause an associated user to be isolated within the data network, however the user may be legitimate, and isolation of the user (or associated computing node) may be inappropriate. Therefore, an artificial intelligence (“AI”) engine may be used to complete the sparse matrix as shown at 804. The shaded elements of the matrix may be the AI engine—generated elements. The AI engine may utilize data from the line of business in which the user operates and/or data previously generated by the user to generate the AI engine—generated elements. The AI engine may complete the sparse matrix with the AI engine—generated elements. As such, the AI engine may modify the sparse matrix into a current matrix.

The AI engine, a second AI engine and/or a processor may generate a delta between the AI completed matrix and the baseline matrix, as shown at 806. The delta may include one or more charts, figures or mathematical elements (not shown). The delta may also include differences between the completed matrix and the baseline matrix (highlighted in bold). When a number of highlighted elements exceeds a predetermined number, the user associated with the matrix may be isolated within the data network. When the evaluated delta exceeds a predetermined delta, the user associated with the matrix may be isolated within the data network.

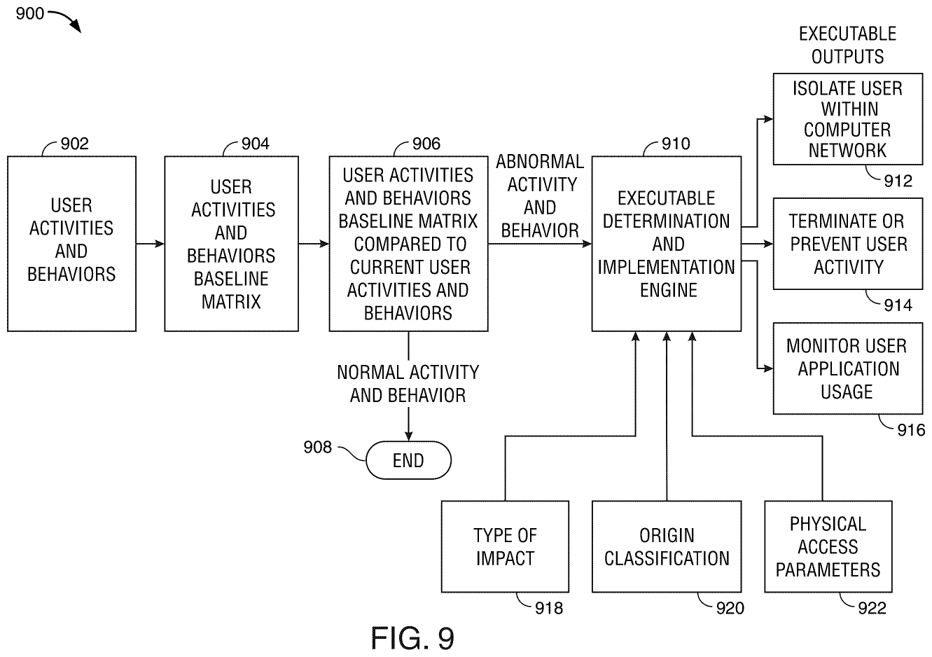

FIG. 9 shows an illustrative diagram. Illustrative diagram 900 shows a process flow. User activities and behaviors may be retrieved, as shown at 902. The user activities and behaviors may be used to generate a baseline matrix, as shown at 904. User activities and behaviors baseline matrix may be compared to current user activities and behaviors, as shown at 906. Normal activity and behavior may end the process, as shown at 908.

Abnormal activity and behavior may initiate an executable determination and implementation engine, as shown at 910. The executable determination and implementation engine 910 may receive a type of impact 918, origin classification 920 and physical access parameters 922. Executable outputs may include isolating a user within the data network, shown at 912, terminating or preventing user activity, shown at 914 and monitoring application usage, shown at 916.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

Thus, methods and apparatus for an artificial intelligence (“AI”) event correlation system are provided. Persons skilled in the art will appreciate that the present disclosure can be practiced by other than the described embodiments, which are presented for purposes of illustration rather than of limitation and that the present disclosure is limited only by the claims that follow.

What is claimed is:

1. A system for isolating intruders within a data network, the system comprising:
a processor operating within the data network, the processor operable to:
during a pre-processing stage:
continually, during a time period initiated upon instantiation of one or more predetermined triggers and concluded at a predetermined timestamp, crawl the data network and retrieve data said data relating to telemetry of a computing node within the data network;
structure the data into one or more data structures ingestible by an empty matrix data structure;
input the data structures into the empty matrix data structure to generate a baseline matrix data structure assigned to the computing node, said baseline matrix data structure corresponding to a multifaceted behavior baseline of the computing node, said baseline matrix characterizing normal behavior and normal activity of the computing node;
during a processing stage:
crawl the data network and retrieve current computing node data, said current computing node data comprising current computing node behavior and activity, said current computing node data being data that occurs within a predetermined time window from a current timestamp;
structure the current computing node data into one or more current computing node data structures ingestible by a second empty matrix;
input the one or more current computing node data structures into the second empty matrix to generate a sparse current matrix for the computing node, said sparse current matrix corresponding to current multifaceted behavior for the computing node, said sparse current matrix characterizing current behavior and activity for the computing node, said sparse current matrix comprising empty sections;
electronically generate, using an artificial intelligence engine retrieving data from the data network, additional data for the empty sections within the sparse current matrix;
input the additional data into the empty sections within the sparse current matrix to modify the sparse current matrix into a current matrix;
electronically generate, at an artificial intelligence engine, a delta between the baseline matrix and the current matrix; and
when the delta exceeds a delta threshold, isolate the computing node and terminate computing node activities within the data network.

2. The system of claim 1 wherein the computing node is included within a network of computing nodes operating on the data network.

3. The system of claim 2 wherein the data also includes data relating to the network of computing nodes.

4. The system of claim 1 wherein the data includes roles for the computing node.

5. The system of claim 1 wherein the one or more predetermined triggers comprise a role change of a user that primarily operates the computing node.

6. The system of claim 1 wherein the one or more predetermined triggers comprise manager change of a user that primarily operates the computing node.

7. The system of claim 1 wherein the delta threshold is generated by an artificially-intelligent engine operable to reduce false positives by creating thresholds appropriate for a line of business within the data network.

8. A system for isolating intruders within a data network, the system comprising:
a processor operating within the data network, the processor operable to:
continually crawl the data network to retrieve data for a predetermined time period, said data relating to telemetry of a user within the data network;
structure the data into one or more data structures ingestible by an empty matrix;
input the data structures into the empty matrix to generate a baseline matrix for the user, said baseline matrix corresponding to a multifaceted behavior baseline for the user, said baseline matrix characterizing normal behavior and normal activity for the user;
upon generation of the baseline matrix, crawl the data network to retrieve current user data, said current user data comprising current user behavior and activity;
structure the current user data into one or more current user data structures ingestible by a second empty matrix;
input the one or more current user data structures into the second empty matrix to generate a current matrix for the user, said current matrix corresponding to current multifaceted behavior for the user, said current matrix characterizing current behavior and activity for the user;
generate a delta between the baseline matrix and the current matrix at an artificial intelligence engine; and
when the delta exceeds a delta threshold, isolate the user within the data network and terminate user activities within the data network.

9. The system of claim 8 wherein the user is included within a network of users operating on the data network.

10. The system of claim 9 wherein the data also includes data relating to the network of users.

11. The system of claim 8 wherein the data includes roles for the user.

12. The system of claim 9 wherein the predetermined time period is sixty days.

13. A system for isolating intruders within a data network, the system comprising:
a processor operating within the data network, the processor operable to:
during a pre-processing stage:
continually, during a time period initiated upon instantiation of one or more predetermined triggers and concluded at a current timestamp, crawl the data network and retrieve data said data relating to telemetry of a user within the data network;
structure the data into one or more data structures ingestible by an empty matrix;
input the data structures into the empty matrix to generate a baseline matrix for the user, said baseline matrix corresponding to a multifaceted behavior baseline for the user, said baseline matrix characterizing normal behavior and normal activity for the user;
during a processing stage:
crawl the data network and retrieve current user data, said current user data comprising current user behavior and activity;
structure the current user data into one or more current user data structures ingestible by a second empty matrix;
input the one or more current user data structures into the second empty matrix to generate a current matrix for the user, said current matrix corresponding to current multifaceted behavior for the user, said current matrix characterizing current behavior and activity for the user;
electronically generate, at an artificial intelligence engine, a delta between the baseline matrix and the current matrix; and
when the delta exceeds a delta threshold, isolate the user and terminate user activities within the data network.

14. The system of claim 13 wherein the user is included within a network of users operating on the data network.

15. The system of claim 14 wherein the data also includes data relating to the network of users.

16. The system of claim 13 wherein the data includes roles for the user.

17. The system of claim 13 wherein the one or more predetermined triggers comprise a role change.

18. The system of claim 13 wherein the one or more predetermined triggers comprise change of manager for the user.

19. The system of claim 13 wherein the delta threshold is generated by an artificially-intelligent engine operable to reduce false positives by creating thresholds appropriate for a line of business within the data network.
